(19) United States
(12) Patent Application Publication
(10) Pub. No.: US 2008/0093973 A1
(43) Pub. Date: Apr. 24, 2008

(54) LIGHT EMISSION DEVICE AND DISPLAY DEVICE

(76) Inventors: Kang-Sik Jung, Yongin-si (KR); Hyun-Chul Lee, Yongin-si (KR); Seung-Hee Jeong, Yongin-si (KR)

Correspondence Address: CHRISTIE, PARKER & HALE, LLP, PO BOX 7068, PASADENA, CA, 91109-7068, US

(21) Appl. No.: 11/759,180

(22) Filed: Jun. 6, 2007

(30) Foreign Application Priority Data
Oct. 24, 2006 (KR) 10-2006-0103406

(51) Int. Cl. H01J 1/62

(52) U.S. Cl. 313/495

(57) ABSTRACT

A light emission device includes a vacuum vessel having a first substrate and a second substrate. The first substrate has a first substrate surface and the second substrate has a second substrate first surface and a second substrate second surface opposing the second substrate first surface. The first substrate surface is separated from the second substrate first surface. An electron emission unit is provided on the first substrate surface. A light emission unit is provided on the second substrate first surface for emitting light in response to receiving electrons emitted from the electron emission unit. A plurality of heat dissipation barrier ribs is provided on the second substrate second surface, the barrier ribs being spaced from each other.

### CROSS-REFERENCE TO RELATED APPLICATION

This application claims priority to and the benefit of Korean Patent Application No. 10-2006-0103406 filed on Oct. 24, 2006, in the Korean Intellectual Property Office, the entire content of which is incorporated herein by reference.

### BACKGROUND OF THE INVENTION

1. Field of the Invention

The present invention relates to a light emission device having improved heat dissipation.

2. Description of Related Art

Generally, electron emission elements use hot cathodes or cold cathodes as an electron emission source. Field Emitter Array (FEA) electron emission elements, Surface-Conduction-Emission (SCE) electron emission elements, Metal-Insulator-Metal (MIM) electron emission elements, and Metal-Insulator-Semiconductor (MIS) electron emission elements are well known cold cathode electron emission elements.

The FEA electron emission element includes electron emission regions and cathode and gate electrodes for controlling the electron emission of the electron emission regions. The electron emission regions include materials that effectively emit electrons using an electric field under a vacuum atmosphere and/or have a relatively low work function or a relatively large aspect ratio. Such materials include Mo-based materials, Si-based materials, and carbon-based materials (e.g., carbon nanotubes, graphite, or diamond-like-carbon). An electron emission region formed from a Si-based material or a Mo-based material is formed in a tip structure.

The electron emission elements are arrayed on a first substrate to form an electron emission device. The electron emission device is combined with a second substrate on which a light emission unit having a phosphor layer and an anode electrode is formed, thereby constituting an electron emission display. In the electron emission display, the first and second substrates are sealed together at their peripheries using a sealing member such as frit bars to form a vacuum vessel. The interior of the vacuum vessel is exhausted to have a vacuum degree of about 10⁻⁶ Torr.

Due to a pressure difference between the interior and exterior of the vacuum vessel, a high compression force is applied to the vacuum vessel, the compression force increasing in proportion to the screen size.

Spacers are provided in the vacuum vessel to endure the compression force and maintain a uniform gap between the first and second substrates. The spacers are formed primarily from dielectrics such as glass or ceramic to prevent a short circuit between the driving electrodes on the first substrate and the anode electrode on the second substrate.

In a conventional electron emission display, heat generated by the driving electrodes is transmitted to the spacers, heating the spacers and causing resistance variation of the spacers. The higher the temperature coefficient of resistance of the spacer material, the higher the resistance variation. The resistance variation of the spacers distorts the electric field around the spacers. Accordingly, a path of electron beams formed by electrons emitted from the electron emission regions and accelerated toward the anode electrode is varied or diffused.

When the electron beam path is varied or diffused, color reproduction around the spacers may not be accurate and temperature variation distorts the visibility of the display.

A liquid crystal display is well known as a typical passive (non-self-emissive) display requiring a light source. A liquid crystal display includes a display panel having a liquid crystal layer and a polarizer plate, and a light emission device emitting light toward the display panel. The display panel receives the light from the light emission device and selectively transmits or blocks the light using the liquid crystal layer and the polarizing plate, thereby displaying an image.

Recently, light emission devices using a cold cathode electron emission source have replaced a cold cathode fluorescent lamp (CCFL), a line light source, and a light emitting diode (LED), a point light source.

Typical light emission devices using cold cathode electron emission sources include a vacuum vessel having electron emission elements, a phosphor layer excited by electrons emitted from the electron emission elements, and an anode electrode for accelerating electrons. Voltages of hundreds to thousands of volts are applied to the anode electrode, resulting in electrons colliding with the phosphor layer and the generation of a large amount of heat transmitted to a substrate. If the heat is not dissipated to the exterior, the substrate may be damaged and/or the device may malfunction.

When a light emission device is used as a light source, a higher luminance is required and a higher voltage is applied to the anode electrode. Therefore, the amount of heat generated by the substrate on which the phosphor layer and the anode electrode are located is greater than heat generated on other substrates, causing more serious heat problems.

### SUMMARY OF THE INVENTION

A light emission device is provided including a vacuum vessel having a first substrate and a second substrate. The first substrate has a first substrate surface, the second substrate has a second substrate first surface and a second substrate second surface opposing the second substrate first surface, the first substrate surface being separated from the second substrate first surface. An electron emission unit is provided on the first substrate surface and a light emission unit is provided on the second substrate first surface for emitting light in response to receiving electrons emitted from the electron emission unit. A plurality of heat dissipation barrier ribs is provided on the second substrate second surface, the barrier ribs being spaced from each other. The heat dissipation barrier ribs may be formed across an active area of the second substrate.

At least one support may be arranged on the plurality of heat dissipation barrier ribs at a periphery of the active area to fix the heat dissipation barrier ribs and the support may intersect the plurality of heat dissipation barrier ribs.

Each barrier rib has a barrier rib first end and a barrier rib second end, a first support intersecting each barrier rib first end and a second support intersecting each barrier rib second end. In another exemplary embodiment a first support is provided for intersecting barrier rib first ends and a second support is provided for intersecting barrier rib second ends. A pair of periphery barrier ribs of the plurality of barrier ribs intersects both the first support and the second support, and adjacent barrier ribs between the pair of periphery barrier ribs alternately intersect the first support and the second support.

A reflective layer may be formed on an inner surface of each heat dissipation barrier rib located on a periphery of the active area. The reflective layer may be metal and may be deposited on each heat dissipation barrier rib located on the periphery of the active area. In one exemplary embodiment, the plurality of heat dissipation barrier ribs are glass and may have a thickness equal to or less than 200 μm.

In another exemplary embodiment, the light emission device further includes a plurality of phosphor layers, a black layer located between the phosphor layers, and an anode electrode located on a phosphor layer surface and a black layer surface, wherein the heat dissipation barrier ribs are aligned with the black layer.

The electron emission unit may further include a first electrode overlapping and insulated from a second electrode and an electron emission region electrically connected to one of the first electrode and the second electrode.

### BRIEF DESCRIPTION OF THE DRAWINGS

FIG. 1 is a partial perspective view of a light emission device according to an exemplary embodiment of the present invention.

FIG. 2 is a top view of heat dissipation barrier ribs shown in FIG. 1.

FIG. 3 is a top view of another exemplary embodiment of heat dissipation barrier ribs of the present invention.

FIG. 4 is a cross sectional view taken along line I-I′ of FIG. 1.

FIG. 5 is a partial top view of another exemplary embodiment of a phosphor layer of the present invention.

FIG. 6 is an exploded perspective view of a display device according to an exemplary embodiment of the present invention.

### DETAILED DESCRIPTION

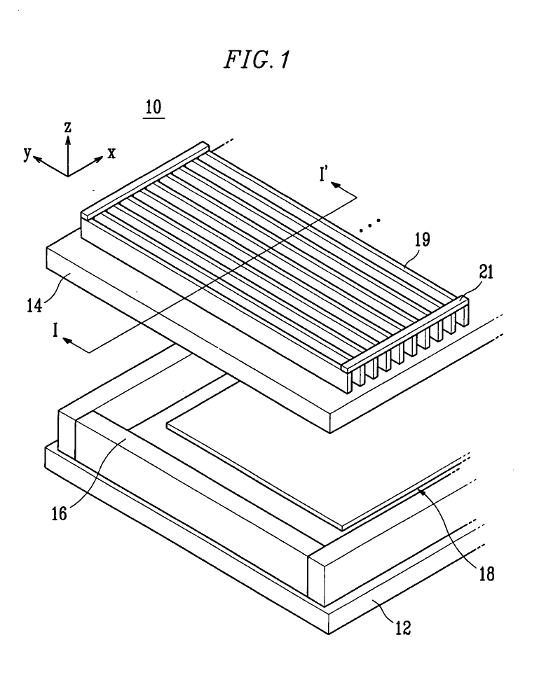

Referring to FIG. 1, a light emission device 10 according to an exemplary embodiment of the present invention includes first and second substrates 12, 14 facing each other and spaced by an interval. A sealing member 16 is provided between peripheries of the first and second substrates 12, 14 to seal them together and form a vacuum vessel. The interior of the vacuum vessel is exhausted to maintain a vacuum degree of about 10⁻⁶ Torr.

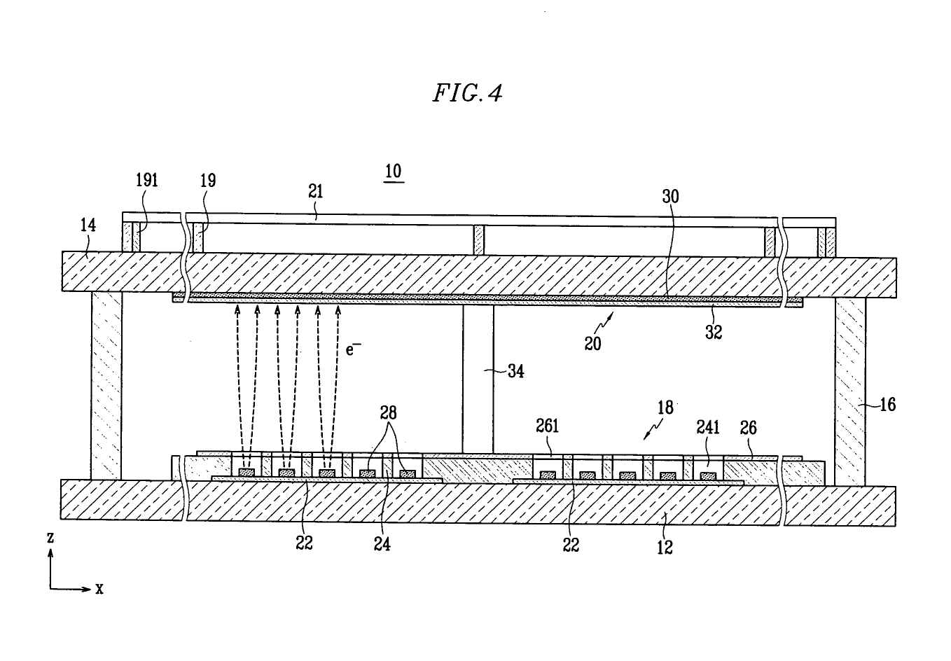

The first and second substrates 12, 14 are divided into an active area substantially emitting visible light inside of the sealing member 16 and an inactive area surrounding the active area. An electron emission unit 18 for emitting electrons is provided at the active area of the first substrate 12 and a light emission unit 20 (FIG. 4) for emitting the visible light is provided at the active area of the second substrate 14. The electron emission unit 18 and the light emission unit 20 will be described in more detail below.

A plurality of heat dissipation barriers 19 are arranged on an outer surface of the second substrate 14 in a first direction (y-axis in FIG. 1) of the second substrate 14 and spaced from each other. Supports 21 for fixing and supporting the heat dissipation ribs 19 are arranged on opposite ends of the heat dissipation barrier ribs 19 in a direction (x-axis in FIG. 1) substantially perpendicular to the heating dissipation barrier ribs 19.

The supports 21 are formed above the heat dissipation barrier ribs 19 to allow air to flow between the heat dissipation ribs 19. In one exemplary embodiment, each of the heat dissipation barrier ribs 19 is a thin plate erected to maximize a contact area of the heat dissipation barrier rib 19 with the fluid, thereby improving the heat dissipation efficiency of the light emission device 10.

In one exemplary embodiment, the heat dissipation barrier ribs 19 may be spaced by regular intervals. For example, the heat dissipation barrier ribs 19 may be located on some or all of portions defined between unit pixels.

The heat dissipation barrier ribs 19 may be formed from transparent glass material so as to minimize interference with light emission from the light emission unit. Alternatively, the heat dissipation barrier ribs 19 may be formed from metal having a high level of thermal conductivity. A thickness of the heat dissipation barrier rib 19 may be less than or equal to about 200 μm for sufficient light transmittance.

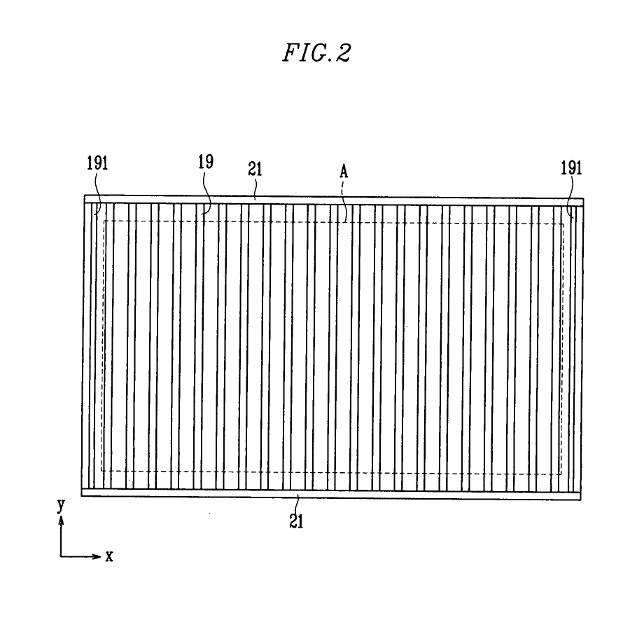

In an exemplary embodiment of the present invention as shown in FIG. 2, the heat dissipation barrier ribs 19 extend continuously across the active area A. However, when the heat dissipation barrier ribs 19 extend intermittently across the active area A, the supports 21 may be arranged at a periphery of the active area A so as not to adversely affect light transmittance. The present invention is not limited to this configuration and, for example, the supports 21 may be arranged within the active area A. In that case, a width of each support should be limited so as not to adversely affect the light transmittance. In one exemplary embodiment, the supports 21 may be formed from the same material as the heat dissipation barrier ribs 19.

Reflective layers 191 are formed on the heat dissipation barrier ribs 19, the reflective layers 191 to reflect light emitted from the light emission unit 20 toward the active area A, thereby enhancing the luminance of the light emission device 10.

The reflective layers 191 may be formed from metal such as aluminum (Al) and they may be deposited on the inner surfaces of the heat dissipation layers 19. The arrangement and coupling of the heat dissipation barrier ribs 19 and the supports are not limited to the above-described configuration and many variations and modifications are possible.

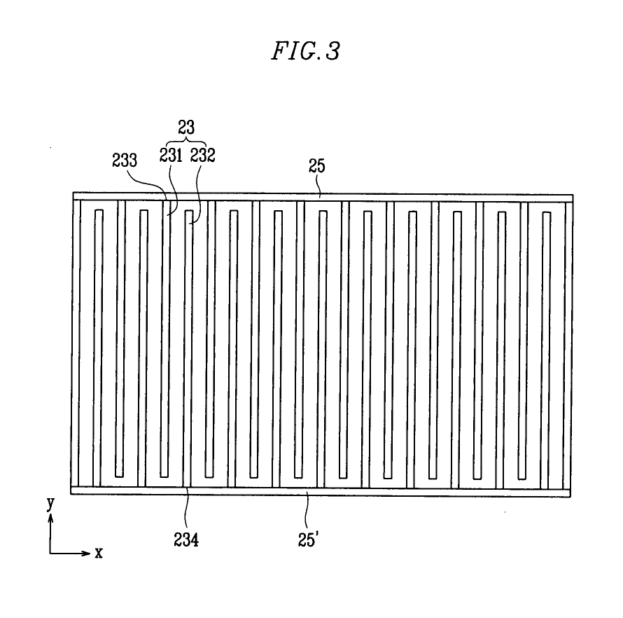

Referring to FIG. 3, each heat dissipation barrier rib 23 includes a first and second end 233, 234. First heat dissipation barrier ribs 231 are connected at the first end 233 with a support 25 and second heat dissipation barrier ribs 232 are connected at the second end 234 with a support 25′. The first and heat dissipation barrier ribs 231, 232 are alternately arranged in parallel along an x-axis as shown in FIG. 3.

FIG. 4 is a partial cross sectional view taken along line I-I′ of FIG. 1, illustrating a detailed structure of the electron emission unit 18 and the light emission unit 20.

The electron emission unit 18 may include Field Emitter Array (FEA) electron emission elements, Surface Conduction Emitter (SCE) electron emission elements, Metal-Insulator-Metal (MIM) electron emission elements, or Metal-Insulator-Semiconductor (MIS) electron emission elements. In FIG. 4, an electron emission unit 18 having FEA electron emission elements is illustrated.

Referring to FIG. 4, the electron emission unit 18 includes first and second electrodes 22, 26 are arranged with an insulation layer 24 interposed therebetween and electron emission regions 28 electrically connected to the first electrodes 22 or the second electrodes 26.

When the electron emission regions 28 are formed on the first electrodes 22, the first electrodes 22 function as cathode electrodes applying a current to the electron emission regions 28 and the second electrodes 26 function as gate electrodes for inducing electron emission by forming an electric field using a voltage difference between the cathode electrodes. On the contrary, when the electron emission regions 28 are formed on the second electrodes 26, the second electrodes 26 function as the cathode electrodes and the first electrodes 22 function as the gate electrodes.

Between the first and second electrodes 22, 26, electrodes extending the x-axis of the light emission device 10 function as scan electrodes and electrodes extending along a y-axis (as shown in FIG. 1) function as data electrodes.

In FIG. 4, the first electrodes 22 are arranged in the x-axis direction and the second electrodes 26 are arranged in the y-axis direction. However, the location of the electron emission regions 28 and the arrangement of the first and second electrodes 22, 26 is not limited to the above case.

Openings 261, 241 are formed respectively on the second electrodes 26 and the insulation layer 24 to partially expose the surface of the first electrodes 22. Electron emission regions 28 are located on the first electrodes 22 in the openings 241.

The electron emission regions 28 are formed of an electron emitting material, such as a carbon-based material or a nanometer-sized material, when an electric field is applied thereto under a vacuum atmosphere. More specifically, the electron emission regions 28 may be formed from carbon nanotubes, graphite, graphite nanofibers, diamonds, diamond-like carbon, fullerene C₆₀, silicon nanowires or a combination thereof. The electron emission regions 28 may be formed through a screen-printing process, a direct growth process, or chemical deposition process.

In one exemplary embodiment, electron emission regions 28 are gathered at a central portion of each intersection of the first and second electrodes 22, 26. Each intersection of the first and second electrodes 22, 26 may correspond to one pixel region of the light emission device 10. Alternatively, two or more of the intersections of the first and second electrodes 22, 26 may correspond to one pixel region of the light emission device 10. In this case, two or more first electrodes 22 and/or two or more second electrodes 26 placed at a common pixel region are electrically connected and powered by a common driving voltage.

The light emission unit 20 includes a phosphor layer 30 and an anode electrode 32 formed on a surface of the phosphor layer 30. The phosphor layer 30 may be formed of a white phosphor layer or of a combination of red, green and blue phosphors, which can emit white light. In FIG. 3, the former is illustrated as an example.

When the phosphor layer 30 is a white phosphor layer, the phosphor layer may be formed on an entire surface of the second substrate 14 or patterned to have a plurality of sections corresponding to the respective pixels.

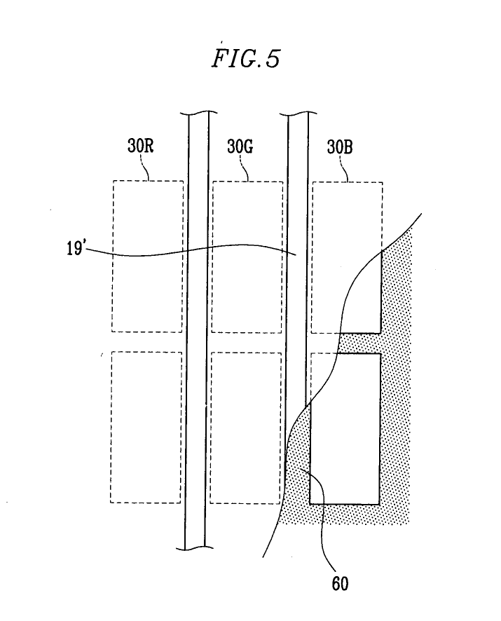

When the light emission device 10 is designed to be used as an imaging display, the phosphor layer 30 is formed with a combination of the red, green and blue phosphor layers. In this case, as shown in FIG. 5, the red, green and blue phosphor layers 30R, 30G, 30B are formed in each pixel region with a predetermined pattern. A black layer 60 may be formed between the red, green, and blue phosphor layers 30R, 30G, 30B. Furthermore, heat dissipation barrier ribs 19′ may be aligned with the black layer 60.

The anode electrode 32 may be formed of a metal layer such as an aluminum (Al) layer covering the phosphor layer 30. The anode electrode 32 is an acceleration electrode that receives a high voltage to maintain the phosphor layer 30 at a high electric potential state. The anode electrode 32 functions to enhance the luminance of the active area by reflecting the visible light, which is emitted from the phosphor layer 30 toward the second substrate 14.

Spacers 34 are located between the first and second substrates 12, 14, the spacer able to withstand a compression force applied to the vacuum vessel 16 and uniformly maintain a gap between the substrates 12, 14.

External driving voltages are applied to the first electrodes 22 and the second electrodes 26 and a positive direct current voltage of thousands of volts is applied to the anode electrode 32 to drive the light emission device 10.

Electric fields are formed around the electron emission regions 28 at the pixels when the voltage difference between the first and second electrodes 22, 26 is equal to or greater than the threshold value, resulting in electrons being emitted from the electron emission regions 28. Attracted by the high voltage to the anode electrode 32, the emitted electrons collide with a corresponding portion of the phosphor layer 30, thereby exciting the phosphor layer 30. A light emission intensity of the phosphor layer of each pixel corresponds to a light emission of the corresponding pixel.

During the above-described driving process, heat generated from the phosphor layer 30 and the anode electrode 32 is dissipated to the exterior through the heat dissipation barrier ribs 19, while the light emitted from the phosphor layer 30 is reflected toward the active area by the reflective layers 191, thereby enhancing an overall luminance of the light emission device 10.

When the above-described light emission device 10 is used as the light source of the display, the light emission device can provide luminance of 10,000 cd/m² at a central portion of the active area. In one exemplary embodiment, a voltage from about 10-15 kV may be applied to the anode electrode 32. Therefore, the first and second substrates 12, 14 are spaced from each other by a distance of about 5-20 mm to avoid electrical instability such as a short circuit in the vacuum vessel caused by high voltage applied to the anode electrode.

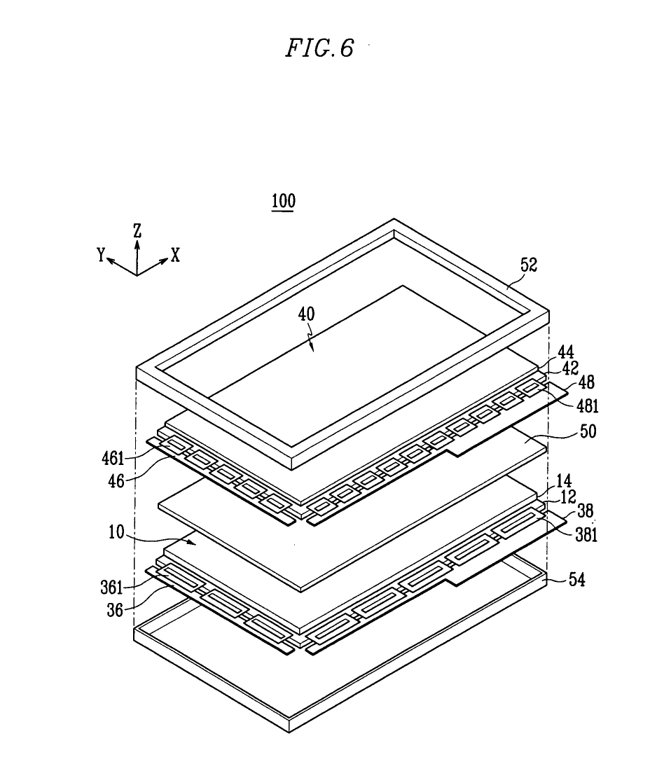

FIG. 6 is an exploded perspective view of a display device according to an embodiment of the present invention. Referring to FIG. 6, a display device 100 includes a display panel 40 located adjacent to the light emission device 10. A diffuser plate 50 for uniformly diffusing light emitted from the light emission device 10 to the display panel 40 may be located between the light emission device 10 and the display panel 40. The diffuser plate 50 may be spaced from the light emission device 10. A top chassis 52 and a bottom chassis may bookend and house components of the light emission device.

Passive-type (non-self-emissive) display panels, such as liquid crystal display panels, may be used as the display panel 40. The display panel 40 may include a thin film transistor (TFT) panel 42 having a plurality of TFTs, a color filter panel 44 located above the TFT panel 42, and a liquid crystal layer (not shown) formed between the panels 42, 44. A polarizing plate (not shown) is attached on the color filter panel 44 and the TFT panel 42 to polarize the light passing through the display panel 40.

The TFT panel 42 may be a transparent glass substrate on which the TFTs are arranged in a matrix pattern. Each TFT has a source terminal connected to data lines, a gate terminal connected to gate lines, and a drain terminal on which pixel electrodes formed of a transparent conductive material are formed.

When an electric signal is input from first printed circuit boards 46, 48 to the respective gate and data lines, the electric signal is input to the gate and source terminals of the TFT. The TFT is turned on or off in accordance with the electric signal to output an electric signal required for forming a pixel to the drain terminal.

The color filter panel 44 is a panel on which RGB pixels, which emit colors when the light passes therethrough, are formed through a thin film process. A common electrode formed of a transparent conductive material is formed on an entire surface of the color filter panel 44. When the TFT is turned on by applying electric power to the gate and source terminals, an electric filed is formed between the pixel electrode and the common electrode of the color filter panel 44. A twisting angle of liquid crystal molecular between the TFT panel 42 and the color filter panel 44 may vary, therefore varying light transmittance of the corresponding pixel.

The first printed circuit boards 46, 48 of the display panel 40 are respectively connected to driving IC packages 461, 481. The gate printed circuit board 46 transmits a gate driving signal and the data printed circuit board 48 transmits a driving signal to drive the display panel 40.

The light emission device 10 includes fewer pixels than the display panel 40 so that one pixel of the light emission device 10 corresponds to two or more pixels of the display panel 40. Each pixel of the light emission device 10 emits light in response to a highest gray level among gray levels of the corresponding pixels of the display panel 40. The light emission device 10 can represent a 2-8 bit gray at each pixel.

For convenience, the pixels of the display panel 40 are referred as first pixels and the pixels of the light emission device 10 are referred as second pixels. The first pixels corresponding to one second pixel are referred as a first pixel group.

During a driving process of the light emission device 10, a signal control unit (not shown) controlling the display panel 40 detects the highest gray level of the first pixel group, operates a gray level required for emitting light from the second pixel in response to the detected high gray level, converts the operated gray level into digital data, and generates a driving signal of the light emission device 10 using the digital data. The driving signal of the light emission device 10 includes a driving signal and a data driving signal.

Second printed circuit boards 36, 38 of the light emission device 10 are connected to driving IC packages 361, 381. In order to drive the light emission device 10, the scan printed circuit board 36 transmits a scan driving signal and the data printed circuit board 38 transmits a data driving signal. The scan driving signal is applied to either the first or second electrode 22, 26 and the data driving signal is applied to the other electrode.

When an image is displayed on the first pixel group, the corresponding second pixel of the light emission device 10 emits light with a predetermined gray level by synchronizing with the first pixel group. The number of pixels of the light emission device in each row and each column may range from 2 to 99. If the number of the pixels in each row and each column is greater than 99, the driving of the light emission device 10 becomes complicated, thereby increasing the manufacturing cost of the driving circuit.

As described above, the light emission device 10 independently controls a light emission intensity of each pixel to provide a proper intensity of light to the corresponding pixels of the display panel 40. As a result, the display device 100 of the present exemplary embodiment can enhance the dynamic contrast of the screen, thereby improving the display quality.

According to the light emission device of the exemplary embodiment of the present invention, heat dissipation barrier ribs are provided on the periphery of the substrate on which the phosphor layer and the anode electrode are located, maximizing heat dissipation efficiency. Furthermore, since the reflective layers are formed on inner surfaces of the heat dissipation barrier ribs, the luminance can be improved. According to the display using the light emission device as a light source, since the screen contrast and screen dynamic contrast are enhanced, the display quality thereof can be improved.

Although exemplary embodiments of the present invention have been described in detail hereinabove, it should be clearly understood that many variations and/or modifications of the basic inventive concept taught herein still fall within the spirit and scope of the present invention, as defined by the appended claims and their equivalents.

What is claimed is:

1. A light emission device comprising:
a vacuum vessel having a first substrate and a second substrate, the first substrate having a first substrate surface, the second substrate having a second substrate first surface and a second substrate second surface opposing the second substrate first surface, the first substrate surface being separated from the second substrate first surface;
an electron emission unit provided on the first substrate surface;
a light emission unit provided on the second substrate first surface for emitting light in response to receiving electrons emitted from the electron emission unit; and
a plurality of heat dissipation barrier ribs provided on the second substrate second surface, the barrier ribs being spaced from each other.

2. The light emission device of claim 1, wherein the heat dissipation barrier ribs are formed across an active area of the second substrate.

3. The light emission device of claim 2, further comprising at least one support arranged on the plurality of heat dissipation barrier ribs at a periphery of the active area to fix the heat dissipation barrier ribs.

4. The light emission device of claim 3, wherein the at least one support intersects the plurality of heat dissipation barrier ribs.

5. The light emission device of claim 1,
wherein each barrier rib has a barrier rib first end and a barrier rib second end, and
wherein a first support intersects each barrier rib first end and a second support intersects each barrier rib second end.

6. The light emission device of claim 1, wherein:
wherein each barrier rib has a barrier rib first end and a barrier rib second end,
wherein a first support is provided for intersecting barrier rib first ends and a second support is provided for intersecting barrier rib second ends,
wherein a pair of periphery barrier ribs of the plurality of barrier ribs intersects both the first support and the second support, and
wherein adjacent barrier ribs between the pair of periphery barrier ribs alternately intersect the first support and the second support.

7. The light emission device of claim 1, wherein a reflective layer is formed on an inner surface of each heat dissipation barrier rib located on a periphery of the active area.

8. The light emission device of claim 7, wherein the reflective layer is metal.

9. The light emission device of claim 8, wherein the reflective layer is deposited on each heat dissipation barrier rib located on the periphery of the active area.

10. The light emission device of claim 1, wherein the plurality of heat dissipation barrier ribs are glass.

11. The light emission device of claim 1, wherein each of the heat dissipation barrier ribs has a thickness equal to or less than 200 μm.

12. The light emission device of claim 1, the light emission device further comprising a plurality of phosphor layers, a black layer located between the phosphor layers, and an anode electrode located on a phosphor layer surface and a black layer surface;
wherein the heat dissipation barrier ribs are aligned with the black layer.

13. The light emission device of claim 1, wherein the electron emission unit comprises:
a first electrode overlapping and insulated from a second electrode; and
an electron emission region electrically connected to one of the first electrode and the second electrode.

14. A display device comprising:
a display panel for displaying an image; and
a light emission device located on one side of the display panel for emitting light toward the display panel,
wherein the light emission device includes:
a vacuum vessel having a first substrate and a second substrate, the first substrate having a first substrate surface, the second substrate having a second substrate first surface and a second substrate second surface opposing the second substrate first surface, the first substrate surface being separated from the second substrate first surface;
an electron emission unit provided on the first substrate surface;
a light emission unit provided on the second substrate first surface for emitting light in response to receiving electrons emitted from the electron emission unit; and
a plurality of heat dissipation barrier ribs provided on the second substrate second surface, the barrier ribs being spaced from each other.

15. The device of claim 14, wherein the plurality of heat dissipation barrier ribs are formed across an active area of the second substrate.

16. The device of claim 15, further comprising at least one support arranged on the plurality of heat dissipation barrier ribs at a periphery of the active area to fix the plurality of heat dissipation barrier ribs.

17. The device of claim 16,
wherein each barrier rib has a barrier rib first end and a barrier rib second end, and
wherein a first support intersects each barrier rib first end and a second support intersects each barrier rib second end.

18. The device of claim 15, wherein a reflective layer is formed on an inner surface of each heat dissipation barrier rib located on the periphery of the active area.

19. The device of claim 14, wherein the display panel is a liquid crystal panel.

20. The device of claim 14, the display panel further comprising first pixels and the light emission device further comprising second pixels,
wherein there are fewer second pixels than first pixels; and
wherein an intensity of light emitted from the second pixels is independently controlled.
